(19) United States
(12) Patent Application Publication
(10) Pub. No.: US 2005/0170117 A1
(43) Pub. Date: Aug. 4, 2005

(54) Multi-layered hose

(76) Inventors: Rafael L. Cleveland, Summerfield, FL (US); Andrew R. Davis, Ocala, FL (US)

Correspondence Address: DAYCO PRODUCTS, LLC, 1 PRESTIGE PLACE, MIAMISBURG, OH, 45342, US

(21) Appl. No.: 10/770,071

(22) Filed: Jan. 31, 2004

(51) Int. Cl. B32B 1/08

(52) U.S. Cl. 428/36.91

(57) ABSTRACT

A flexile hose for use in conveying fluids comprising: a solid inner tubular structure of a non-foamed thermoplastic vulcanizate material having an inner circumferential surface through which fluids are conveyed, and an outer circumferential surface; a reinforcement material telescoped over the outer surface of the foamed thermoplastic vulcanizate material; and a foamed thermoplastic vulcanizate material having an inner surface and an outer surface, the inner surface of which circumferentially encompasses the reinforcement material forming a cover thereon, and a method for manufacturing such hose are described.

### RELATED APPLICATION

Filed concurrently with this application is U.S. Ser. No. ______ to Cleveland et al. entitled “Multi-Layered Flexible Tube”.

### BACKGROUND OF THE INVENTION

This invention relates to hoses and especially to flexible hoses for use in industrial, commercial and automotive applications. The present flexible hoses are particularly useful in the automotive industry for conveying fluids in heater systems and coolant systems.

Hoses, in general, have been constructed from various polymeric materials such as natural rubber, synthetic rubber such as styrene-butadiene rubber (SBR), neoprene, ethylene-propylene rubber (EPR), butyl rubber, polybutadiene, polyisoprene, nitrile-butadiene rubber (NBR), polybutylene, ethylene-propylene diene terpolymers (EPDM) and the like; blends of such natural and synthetic rubbers; vulcanized blends of natural and synthetic rubbers; blends of natural and/or synthetic rubbers with, e.g., vinyl resins; and thermoplastic materials such as polyolefins, polyurethanes, etc. Depending upon the application, various hoses are required to exhibit certain characteristics, e.g., certain hoses are required to have a high degree of flexibility, be light weight and economical to manufacture, and be able to accommodate hot liquids such as water or other fluids without undue deterioration or other damage to the hose. Traditionally, coolant and heater hoses, in particular, have been constructed from EPDM rubber that requires vulcanization in order to achieve its final form. Such rubber compounds pose a number of problems for the manufacturer. For example, vulcanized rubber is not easily recyclable; rubber extrusion is slow causing undesirable cure lumps, die marks and scorched compound if it runs too fast; rubber extrusion is very sensitive to heating/cooling cycles of the extruder; vulcanized rubber is not cost effective, requiring additional expensive equipment as well as an extra processing step; rubber products exhibit high batch-to-batch variability leading to inconsistent and unr liable product; and rubb r products, in gen ral, have an und sirable high specific gravity.

Accordingly, there is a growing demand in the industry for hoses to be constructed from materials which are more economical, lighter in weight and which exhibit improv d recyclability when compared to the prior art materials. Therefore, it is a primary object of the present invention to provide a hose constructed from certain polymeric materials that overcomes the above disadvantages. It is another object of the invention to provide a method for the manufacture of such hoses.

### SUMMARY OF THE INVENTION

In accordance with the invention, a flexible hose which generally comprises a reinforcement member having at least one layer of a thermoplastic vulcanizate on each side of the reinforcement member, and a method for manufacturing such hose are provided.

In one embodiment of the invention, the hose comprises a thermoplastic vulcanizate inner tubular structure, a reinforcement member surrounding the first thermoplastic vulcanizate inner tubular structure, and a thermoplastic vulcanizate cover layer which may or may not be foamed surrounding the reinforcing layer.

Multiple layered hoses including hoses, which contain foamed and non-foamed layers, are known in the art. For example, U.S. Pat. No. 4,644,977 to Arterbum discloses a reinforced, lightweight, flexible hose which comprises a two-component tube consisting of a thin, non-foamed inner liner and a foamed layer circumferentially encompassing the inner layer; a textile reinforcement telescoped over the two-component tube; and a two-component, coextruded, thermoplastic outer cover layer circumferentially encompassing the reinforcing tube, wherein the two-component coextruded thermoplastic outer cover includes a first thermoplastic layer with a multitude of closed gas-filled cells and a second thermoplastic which is non-foamed. The second, non-foamed thermoplastic layer has a thickness of from 15% to 73% of the thickness of the first thermoplastic layer and forms the outer surface of the hose. The coextruded first and second thermoplastic layers are specifically characterized as being free of any intervening material.

U.S. Pat. No. 3,547,162 to Schaerer t aches a synthetic plastic pip embedded in a rigid building mat rial for us as a wat r conduit for transporting hot water. The mbedded pipe includes an inner crosslinked olefin polymer; an intermediat reinforcing layer comprising a braided jacket of natural, semi-synthetic fibers; and an outer layer of synthetic plastic foam surrounding the intermediate reinforcing layer.

In accordance with the invention, the foamed and non-foamed thermoplastic vulcanizate materials employed to construct the present heater hose comprise an appropriate thermoplastic polymer matrix such as polypropylene, polyurethane and the like, wherein the polymer matrix contains a plurality of small elastomeric globules randomly dispersed throughout the thermoplastic polymer matrix. Generally, the small elastomeric globules are, at least partially, vulcanized. The thermoplastic vulcanizates of the present typically comprise about 75 to 25% thermoplastic polymer matrix and about 25 to 75% elastomeric globules having a particle size of less than 50 microns. The elastomeric globules in the matrix will be at least about 50% cured and preferably, about 50 to 100% cured. Most preferably, the elastomeric globules will be greater than about 95% cured.

One advantage realized in the hose construction of the invention is that the present flexible hose is more economical to manufacture when compared to prior art hoses.

Another advantage of the hose construction of the invention is that the present flexible hose is lighter in weight when compared to prior art hoses.

Yet another advantage of the invention is that the present hose has superior recyclability when compared to prior art hoses.

Still another advantage of the hose construction of the invention is that the physical properties of the present flexible hose are more consistent than in prior art hoses.

### BRIEF DESCRIPTION OF THE DRAWINGS

FIG. 1 is a perspective view of the multi-layer TPV hose of the invention;

FIG. 2 is a transverse cross-sectional view of a first embodiment of the multi-layer TPV hose of th invention;

FIG. 3 is a transverse cross-sectional vi w of the first embodiment of the multi-layer TPV hose of the invention showing an optional asp ct thereof;

FIG. 4 is a transverse cross-sectional view of a second embodiment of the multi-layer TPV hose of the invention;

FIG. 5 is a transverse cross-sectional view of the second embodiment of the multi-layer TPV hose of the invention showing an optional aspect thereof; and

FIG. 6 is a diagram illustrating the various steps employed, including optional steps, in the manufacture of the multi-layer TPV hose of the invention.

### DETAILED DESCRIPTION OF THE INVENTION

Hoses for use in the automotive industry, for example, are typically manufactured from EPDM, which provides a high level of flexibility to the hose. However, EPDM exhibits other characteristics which are less than desirable as described above; therefore, there is a need to find some other suitable material which would be more cost effective, lighter in weight and have better recyclability than EPDM, for the manufacture of hoses. It has been found that hoses which are manufactured from certain thermoplastic vulcanizate materials having a thermoplastic polymer matrix containing minor amounts of a cured elastomeric material in the form of globules, not only exhibit excellent flexibility but are also lighter in weight (up to 30% lighter than EPDM), have improved recyclability and are more economical to produce than hoses of the prior art. Thermoplastic compositions containing a blend of a thermoplastic continuous phase and a rubber material are described in U.S. Pat. No. 4,226,953 to Coran et al.; U.S. Pat. No. 4,141,863 to Coran et al.; U.S. Pat. No. 4,130,535 to Coran et al.; U.S. Pat. No. 5,397,839 to Patel; U.S. Pat. No. 5,550,190 to Hoosegow et al.; U.S. Pat. No. 5,376,723 to Vogt et al.; U.S. Pat. No. 6,207,752 to Abraham et al.; and U.S. Pat. No. 6,524,673 to Bhattacharrya, among others.

In accordance with a first embodiment of the invention, a hose is provided which comprises a multipl layer construction wherein a first layer of solid thermoplastic vulcanizate (TPV) is used to form a non-foamed inner tubular structure through which a fluid is conveyed. Th inner tubular structure is covered with a reinforcement member, and a second layer of a th rmoplastic vulcanizate is telescoped over the reinforcement m mber to form a protective cover for the hose. The thermoplastic vulcanizate protective cover layer may or may not be foam d.

According to a second embodiment of the invention, a hose is provided which contains an additional foamed thermoplastic vulcanizate layer between the non-foamed thermoplastic vulcanizate inner tubular structure and the reinforcement member. The additional foamed thermoplastic vulcanizate layer has been found to extend the life of the hose by reducing or preventing reinforcement pull-out. The thickness of the optional foamed intermediate TPV layer is approximately 0 to 25% of the total thickness of the hose and the thickness of the optional foamed cover layer is about 15 to 55% of the total thickness of the hose.

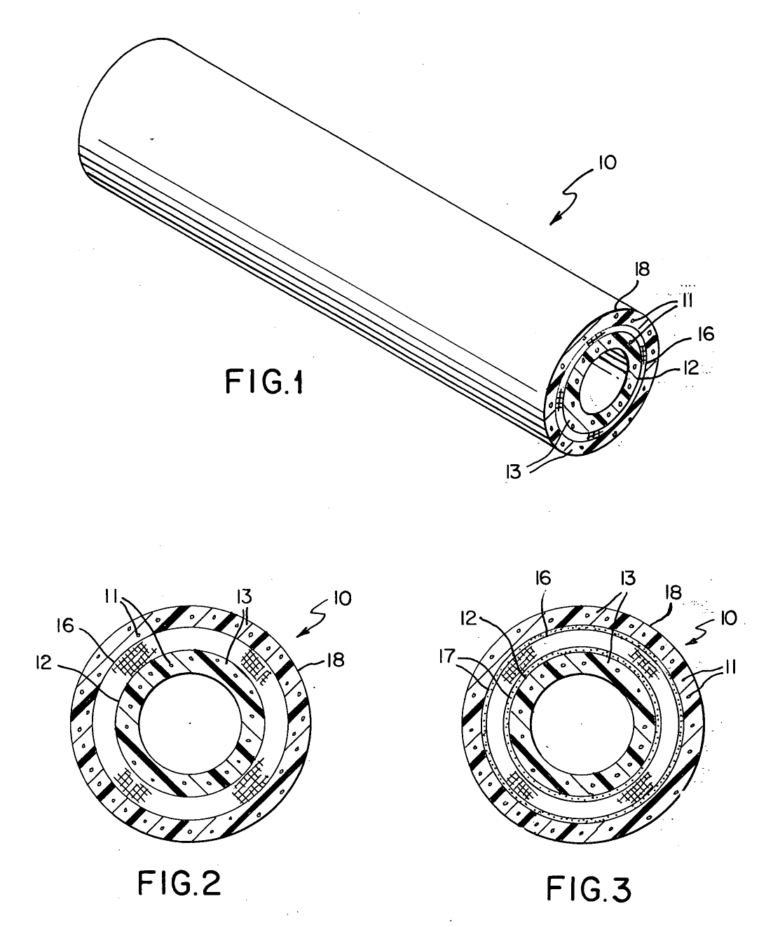

Referring to FIGS. 1 and 2, a hose 10 consists of a solid, non-foamed thermoplastic vulcanizate inner tubular structure 12. A reinforcing layer 16, which provides strength and structural integrity to the hose 10, is disposed on the adjacent outer surface of the non-foamed TPV inner tubular structure 12. An outer cover layer 18 consisting of a thermoplastic vulcanizate layer is disposed on the outer surface of the reinforcing layer 16. The outer layer 18 may or may not be foamed depending on the desired characteristics of the hose 10. As shown in FIG. 2, the thermoplastic vulcanizate contains a plurality of small, cured elastomeric globules 11 randomly dispersed in a thermoplastic vulcanizate matrix 13.

The hose 10 of the first embodiment of the invention may also include one or more layers of an adhesive material between the various layers. For example, hose 10 as shown in FIG. 3 includes adhesive layers 17 between the thermoplastic vulcanizate inner tubular structure 12 and the reinforcement member 15, and between the reinforcement member 16 and the thermoplastic vulcanizate cover 18, which may or may not be foamed. The adhesive material selected should have sufficient adhesive characteristics to effectively adhere the inner thermoplastic vulcanizate to the reinforcement layer. Typically, the adhesive is a layer of rubber such as ethylene-propylene-diene terpolymer (EPDM) or other appropriate rubber, which provides effective adhesion between the thermoplastic vulcanizate inner layer and the reinforcement layer.

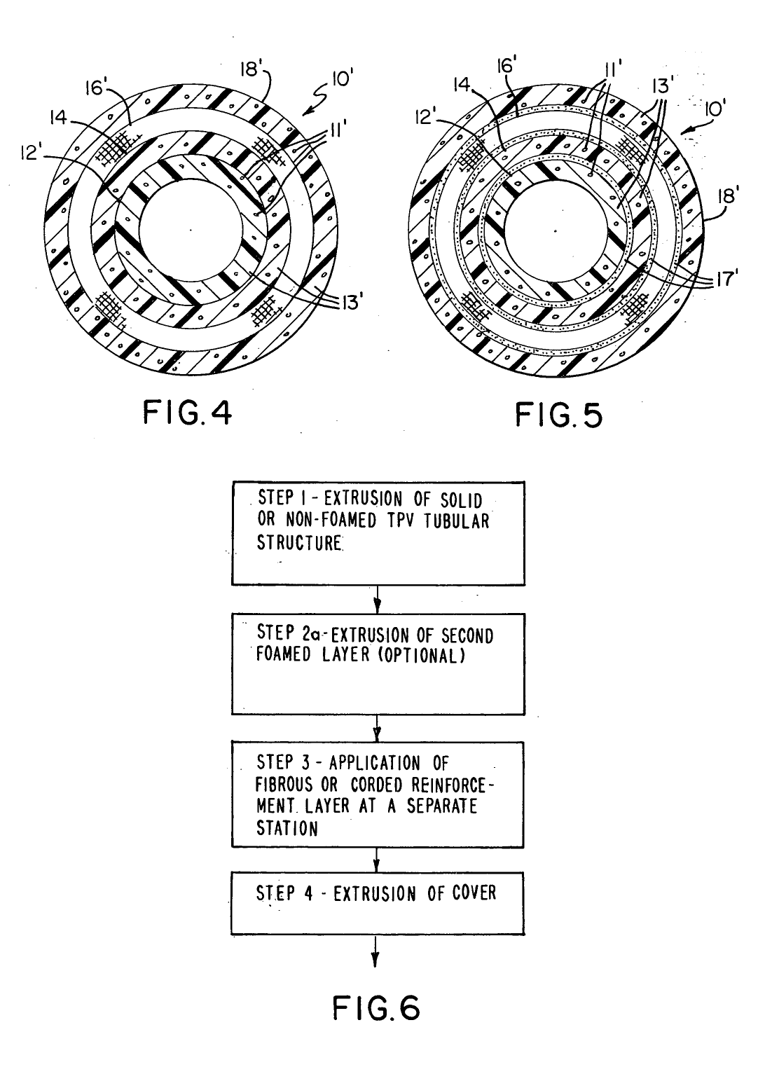

A second mbodiment of th invention is illustrat d in FIG. 4 where a hos 10′ consists of a solid non-foamed thermoplastic vulcanizate inner tubular structure 12′. A foamed thermoplastic vulcanizate lay r 14 is formed adjacent the inn r tubular structure 12′ and a reinforcing layer 16′, which provides strength and structural integrity to the hose 10, is disposed on the adjacent outer surface of the foamed TPV intermediate layer 14. An outer cover layer 18′ consisting of a thermoplastic vulcanizate is disposed on the outer surface of the reinforcing layer 16′. The outer layer 18′ may or may not be foamed depending on the desired characteristics of the hose 10. Each of the thermoplastic vulcanizate layers of the hose 10′ contains a plurality of small elastomeric globules 11′ in the thermoplastic matrix 13′.

As in the first embodiment of the invention, the hose 10′ of the second embodiment also may or may not contain one or more layers of an adhesive material between the various layers of the hose 10′. For example, hose 10′ as shown in FIG. 5 includes a plurality of adhesive layers 17′ between the inner tubular structure 12′ and the foamed intermediate THV layer 14, between the foamed intermediate layer 14 and the reinforcement member 15′, and between the reinforcement member 16′ and the THV cover 18′ which may or may not be foamed.

The thermoplastic vulcanizate material used to manufacture the hose of the present invention includes, as the matrix, one or more light weight thermoplastic polymers which are economical to use and process. Typically, such thermoplastic vulcanizate materials include polyolefins such as polyethylene, polypropylene, 1-butene, 1-pentene, 1-hexene, isobutylene, 3-methyl-1-pentene, 4-methyl-1-pentene, 5-methyl-1-hexene, etc. and mixtures thereof; polyamide; polyurethane; and the like as a matrix, having dispersed therein small globules of a cured, or at least partially cured, elastomeric material such as ethylene-propylene-diene rubber (EPDM), ethylene-propylene rubber, nitrile-butadiene rubber (NBR), hydrogenated nitrile-butadiene rubber (HNBR), styrene-butadiene rubber (SBR), ethylene-acrylic copolymers (AEM), polyacrylate (ACM), chlorinated polyethylene (CPE), chlorinated polypropylene, chlorosulfonated polyethylene (CSM), chlorosulfonated polypropylene, and the like, having a particle size of about 50 microns or less, preferably about 5 to 50 microns.

The elastomeric globules dispersed in the thermoplastic vulcanizate is at least partially cured using one or more curing agents known in the art. Examples of such curing agents include peroxides, azides, sulfur, amines, etc. Partial or complete crosslinking can be achieved by adding a sufficient amount of one or more of the appropriate crosslinking ag nts to the composition to crosslink the elastomeric globules to th desired degree under conventional crosslinking conditions. The elastom ric globules can also b crosslinked by dynamic vulcanization wherein the elastomeric globules are vulcanized under the conditions of shear at a temperature above the melting point of the thermoplastic polymer component. The elastom ric component of the thermoplastic vulcanizate is thus simultaneously crosslinked and dispensed as fine particles or globules within the thermoplastic matrix.

The reinforcement layer can be of any desired configuration such as knit, spiraled, braided, woven, maypole, rotary, wrap, longitudinally overlapped textile, etc. Any of the conventional materials used as a reinforcement in the manufacture of hoses can be employed as the reinforcement layer in the present invention. Typically, such reinforcement materials include natural or synthetic yam, textile sheets, etc. formed from natural or synthetic fibers such as nylon fibers, rayon fibers, aramid fibers, polyester fibers, cotton fibers, glass fibers, carbon fibers, polyester fibers, and the like, as well as metal wire.

The thermoplastic vulcanizate material used as the various tubular structure of the hose of the present invention may be of the same composition or they may be a different composition.

It is generally desirable to utilize the same thermoplastic polymer material as the matrix for the various layers such as the inner tubular structure, the intermediate foamed layer, and the protective cover layer of the present hose. It is, however, within the scope of the invention to employ different thermoplastic vulcanizate polymers as the matrix in the various layers. For example, the thermoplastic polymer matrix in the sold thermoplastic vulcanizate inner tubular structure may be of one thermoplastic polymer, while the thermoplastic polymer in either of the foamed intermediate layer and/or the protective cover layer may be of another thermoplastic polymer.

The foamed intermediate thermoplastic layer covering the inner tubular structure and the foamed cover are foamed using one or more conventional foam-forming agents, such as chemical foaming agents (CFA), dispersed throughout the thermoplastic vulcanizate material. Generally, the foaming agent is added to the thermoplastic vulcanizate in microsphere plastic particles or in pellet form prior to extrusion. Foaming the thermoplastic vulcanizate material results in the activation of th foam-forming ag nt causing the formation of a plurality of minute closed cells spaced within the thermoplastic vulcanizate material. Pref rable, the CFA is one that rel ases either N₂, CO₂, CO or H₂O. A preferred CFA is a blend of citric acid and sodium bicarbonate. Examples of other CFA include azodicarbamide, modified azodicarbamide, hydrazide, 5-phenyltetrazol, p-toluene sulfonyl semicarbazide, N,N′-dinitrosopentamethylenetetraamine, benzenesulfonyl hydrazide, p-toluene sulfonyl hydrazide, p,p′-oxybis(benzenesulfonyl hydrazide), and the like. In addition to chemical foaming agents, the thermoplastic vulcanizate materials expanded by water foaming have also been found to be effective in providing the foamed thermoplastic vulcanizate layers of the present invention. Typically, the foamed thermoplastic vulcanizate exhibits a specific gravity of about 0.55 to 0.90.

The various thermoplastic vulcanizate layers may contain one or more conventional additives known in the art to provide one or more desirable characteristics. Such additives may include, extenders, antioxidants, stabilizers, rubber processing oil, extender oil, lubricants, plasticizers, antiblocking agents, pigments, flame retardants, conductive agents and other additives known in the rubber and plastic compounding art. The specific additives and the amounts of such additives will be that which is conventionally used in the art to provide the desired effect in the manufacture of hoses. Generally, the techniques and substances used for bonding the various layers together are those adhesives and methods designed to satisfy a particular demand on the hose. Such techniques and substances are known; therefore, the invention is not intended to be limited to any specific adhesive or method for bonding the layers together.

A method for manufacturing the thermoplastic vulcanizate hose of the present invention is illustrated in FIG. 6 and is further described as follows. In step (1), a non-foamed or solid thermoplastic material is extruded to form a solid or non-foamed thermoplastic vulcanizate tubular structure. Step (2) provides for the application of a fibrous or corded layer of reinforcing material around the inner thermoplastic vulcanizate tubular structure. Step (3) provides for the extrusion of an outer cover layer of TPV material onto the reinforcing material. The thermoplastic vulcanizate protective cover may be foamed prior to extrusion of the hose or, preferably, during extrusion of the hose. Step (2a) is an optional step where, in another embodiment of the invention, an intermediate layer of thermoplastic vulcanizate may be extruded over the solid, non-foamed thermoplastic vulcanizate inner tubular structure between step (1) and step (2). The intermediate layer is preferably foamed during extrusion. It will be noted that one or more additional steps may be optionally included between steps (1) and (2) and between steps (2) and (3) of the first embodiment, wh rein one or mor layers of adhesive may be applied b tween the specified steps to increase bonding therebetween. Alternatively, the adhesive may be included in any or all of the various layers, i.e., in the solid, non-foamed th rmoplastic vulcanizate tubular structure, the reinforcement layer and/or in the outer thermoplastic vulcanizate protective cover layer.

While certain aspects and embodiments of the present invention have been specifically illustrated and described herein, it will be understood that various other aspects and embodiments, and modifications thereof may be practiced without deviating from the scope of the invention.

1. A flexible hose comprising:
an inner tubular structure comprising a first thermoplastic vulcanizate, said inner tubular structure having an inner circumferential surface through which fluids are conveyed, and an outer circumferential surface; and
a protective cover comprising a second thermoplastic vulcanizate; and
a reinforcement member disposed between said inner tubular structure and said protective cover.

2. The hose of claim 1 wherein each of said first thermoplastic vulcanizate and said second thermoplastic vulcanizate comprises a thermoplastic polyolefin, polyamide, or polyurethane matrix containing a plurality of elastomeric globules selected from the group consisting of ethylene-propylene-diene rubber, ethylene-propylene rubber, nitrile-butadiene rubber, hydrogenated nitrile-butadiene rubber, styrene-butadiene rubber, ethylene-acrylate copolymers, chlorinated polyethylene, chlorinated polypropylene chlorosulfonated polyethylene and chlorosulfonated polypropylene dispersed therein.

3. The hose of claim 2 wherein said each of said thermoplastic vulcanizates comprises a polypropylene matrix containing a plurality of elastomeric ethylene-propylene-diene rubber globules dispersed therein.

4. The hose of claim 3 wherein said propylene matrix comprises about 75 to 25% by weight of said thermoplastic vulcanizate and said plurality of elastomeric globules comprises about 25 to 75% by weight of said thermoplastic vulcanizate.

5. The hose of claim 2 wherein said plurality of elastomeric ethylene-propylene-diene rubber globules are at least partially crosslinked.

6. The hose of claim 1 wherein said reinforcement member comprises natural fibers, synthetic fibers or metal wire

7. The hose of claim 6 wherein said reinforcement member comprises natural or synthetic fibers selected from the group consisting of nylon fibers, rayon fib rs, aramid fibers, cotton fibers, carbon fibers, glass fibers and polyester fibers.

8. Th hose of claim 6 wherein said reinforcement member is steel wire.

9. The hose of claim 1 wherein said reinforcement material is knitted, braided, spiraled, woven, maypole, rotary, wrapped, or longitudinally overlapped textile on said inner tubular structure.

10. The hose of claim 1 wherein said second thermoplastic vulcanizate is foamed.

11. The hose of claim 10 further comprising a third thermoplastic vulcanizate disposed between said inner tubular structure and said reinforcement member wherein said third thermoplastic vulcanizate is foamed.

12. The hose of claim 11 wherein said second foamed thermoplastic vulcanizate and said third foamed thermoplastic vulcanizate material exhibit a closed cell structure comprising a thermoplastic polypropylene matrix having dispersed therein a plurality of elastomeric ethylene-propylene-diene rubber globules and a foaming agent, said foamed thermoplastic vulcanizate material exhibiting a specific gravity of about 0.55 to 0.90.

13. The hose of claim 1 further comprising an adhesive layer between at least one of said thermoplastic vulcanizate inner tubular structure and said reinforcement member, and between said reinforcement member and said thermoplastic vulcanizate protective cover.

14. The hose of claim 13 wherein said adhesive layer is ethylene-propylene-diene rubber.

15. A flexible hose comprising:
an inner tubular structure comprising a solid, non-foamed thermoplastic vulcanizate having a thermoplastic polypropylene matrix containing a plurality of crosslinked elastomeric ethylene-propylene0diene rubber globules having a particle size of about 5 to 50 microns dispersed therein, said inner tubular structure having an inner circumferential surface through which fluids are conveyed, and an outer circumferential surface, said solid, non-foamed thermoplastic vulcanizat containing about 25 to 75% elastomeric globules by w ight of said thermoplastic vulcanizate and about 75 to 25% th rmoplastic polypropylene matrix by weight of said thermoplastic vulcanizate;
a r inforcement member comprising natural or synth tic fibers selected from the group consisting of nylon fibers, rayon fibers, aramid fibers, cotton fibers, carbon fib rs, glass fibers and polyester fib rs, or metal wire, said reinforcement member t lescoped over the outer surface of said solid, non-foamed inner tubular structure; and
a protective cover comprising a thermoplastic vulcanizate comprising a thermoplastic polypropylene matrix containing a plurality of crosslinked elastomeric ethylene-propylene-diene rubber globules having a particle size of about 5 to 50 microns dispersed therein, said foamed thermoplastic vulcanizate material having an inner surface and an outer surface, the inner surface of said foamed thermoplastic vulcanizate material circumferentially encompassing said reinforcement material forming a cover thereon, said thermoplastic vulcanizate containing about 25 to 75% elastomeric globules by weight of said thermoplastic vulcanizate and about 75 to 25% thermoplastic polypropylene matrix by weight of said thermoplastic vulcanizate.

16. The hose of claim 15 wherein said reinforcement material is knitted, braided, spiraled, woven, maypole, rotary, wrapped, or longitudinally overlapped textile on said inner tubular structure.

17. The hose of claim 16 further comprising an adhesive layer between at least one of said thermoplastic vulcanizate inner tubular structure and said reinforcement member, and between said reinforcement member and said thermoplastic vulcanizate protective cover.

18. The hose of claim 17 wherein said adhesive layer is ethylene-propylene-diene rubber.

19. A flexible hose comprising in order:
an inner tubular structure comprising a non-foamed thermoplastic vulcanizate having a thermoplastic polypropylene matrix containing a plurality of crosslinked elastomeric ethylene-propylene-diene rubber globules having a particle size of about 5 to 50 microns dispersed therein, said inner tubular structure having an inner circumferential surface through which fluids are conveyed, and an outer circumferential surface, said solid, non-foamed thermoplastic vulcanizate containing about 25 to 75% elastomeric globules by weight of said thermoplastic vulcanizate and about 75 to 25% thermoplastic polypropylene matrix by weight of said thermoplastic vulcanizate;
a foamed intermediate layer comprising a foamed thermoplastic vulcanizate having a thermoplastic polypropylene matrix containing a plurality of crosslinked lastomeric ethylene-propylene-diene rubber globules having a particle size of about 5 to 50 microns dispersed therein, said intermediate layer having an inner circumferential surface and an outer circumf rential surface, said intermediate layer of thermoplastic vulcanizate containing a plurality of crosslinked ethylene-propylene-diene rubber globules having a particle size of about 5 to 50 microns dispersed therein, said intermediate vulcanizate containing about 25 to 75% of said ethylene-propylene-diene rubber globules by weight of said thermoplastic vulcanizate and about 75% to 25% of said thermoplastic polypropylene matrix by weight of said thermoplastic vulcanizate wherein said intermediate vulcanizate is disposed between said inner tubular structure and said reinforcement member, said foamed intermediate thermoplastic vulcanizate layer having been foamed by the action of a foaming agent present therein;
a reinforcement member comprising natural or synthetic fibers selected from the group consisting of nylon fibers, rayon fibers, aramid fibers, cotton fibers, carbon fibers, glass fibers and polyester fibers, or metal wire, said reinforcement member telescoped over the outer circumferential surface of said foamed intermediate thermoplastic vulcanizate; and or metal wire; and
a foamed protective cover comprising a foamed thermoplastic vulcanizate having a thermoplastic polypropylene matrix containing a plurality of crosslinked elastomeric ethylene-propylene-diene rubber globules having a particle size of about 5 to 50 microns dispersed therein, said intermediate vulcanizate containing about 25 to 75% of said ethylene-propylene-diene rubber globules by weight of said thermoplastic vulcanizate and about 75 to 25% of said thermoplastic polypropylene matrix by weight of said thermoplastic vulcanizate, said foamed thermoplastic vulcanizate material having an inner circumferential surface and an outer circumferential surface, the inner circumferential surface of said thermoplastic vulcanizate material surrounding said reinforcement material forming a thermoplastic vulcanizate protective cover thereon, said thermoplastic vulcanizate protective covering having been foamed by the action of a foaming agent present therein.

20. The hose of claim 19 wherein said reinforcement material is knitted, braided, spiraled, woven, maypole, rotary, wrapped, or longitudinally overlapped textile on said inner tubular structure.

21. The hose of claim 19 furth r comprising an adhesive lay r b tw en atl ast one of said thermoplastic vulcanizate inner tubular structure and said foamed intermediate layer, b tween said foamed intermediate layer and said reinforcement member, and between said reinforcement member and said foamed thermoplastic vulcanizat protective cover.

22. The hose of claim 19 wherein said foaming agent is a chemical foaming agent selected from the group consisting of blends of citric acid and sodium bicarbonate, azodicarbamide, modified azodicarbamide, hydrazide, 5-phenyltetrazol, p-toluene suffonyl semicarbazide, N,N′-dinitrosopentamethylenetetraamine, benzenesulfonyl hydrazide, p-toluene sulfonyl hydrazide, and p,p′-oxybis(benzenesulfonyl hydrazide).

23. The hose of claim 22 wherein said chemical foaming agent is a blend of citric acid and sodium bicarbonate.

24. The hose of claim 19 wherein each of said foamed thermoplastic vulcanizates having been foamed during extrusion of said hose.

25. The hose of claim 19 wherein said foamed intermediate thermoplastic vulcanizate layer and said foamed thermoplastic vulcanizate protective cover layer exhibits a closed cell structure having a specific gravity of about 0.55 to 0.90.

26. The hose of claim 19 further comprising an adhesive layer between at least one of said thermoplastic vulcanizate inner tubular structure and said foamed intermediate thermoplastic layer, said foamed intermediate thermoplastic layer and said reinforcement member, and said reinforcement member and said foamed thermoplastic vulcanizate protective cover.

27. The hose of claim 26 wherein said adhesive layer is ethylene-propylene-diene rubber.

28. A method of manufacturing a flexible hoes for use in conveying a fluid, said method comprising:
extruding a first thermoplastic vulcanizate tubular structure having an inner surface and an outer surface;
applying a reinforcement member on the outer surface of said first thermoplastic vulcanizate tubular structure;
extruding a s cond thermoplastic vulcanizate tubular structure around said reinforcement.

29. The method of claim 28 wherein each of said first th rmoplastic vulcanizate and said second thermoplastic vulcanizate comprises a thermoplastic polyolefin, polyamide, or polyurethane matrix containing a plurality of elastomeric globules selected from the group consisting of ethylene-propylene-diene rubber, ethylene-propylene rubber, nitrile-butadiene rubber, hydrogenated nitrile-butadiene rubber, styrene-butadiene rubber, ethylene-acrylate copolymers, chlorinated polyethylene, chlorinated polypropylene, chlorosulfonated polyethylene, and chlorosulfonated polypropylene dispersed therein.

30. The method of claim 29 wherein said each of said thermoplastic vulcanizates comprises a polypropylene matrix containing a plurality of elastomeric ethylene-propylene-diene rubber globules dispersed therein.

31. The method of claim 30 wherein said polypropylene matrix comprises about 75 to 25% by weight of said thermoplastic vulcanizate and said plurality of elastomeric globules comprises about 25 to 75% by weight of said thermoplastic vulcanizate.

32. The method of claim 30 wherein said plurality of elastomeric ethylene-propylene-diene rubber globules are at least partially crosslinked.

33. The method of claim 28 wherein said reinforcement member comprises natural fibers, synthetic fibers or metal wire.

34. The method of claim 33 wherein said reinforcement member comprises natural or synthetic fibers selected from the group consisting of nylon fibers, rayon fibers, aramid fibers, cotton fibers, carbon fibers, glass fibers and polyester fibers.

35. The method of claim 33 wherein said reinforcement member is steel wire.

36. The method of claim 28 wherein said reinforcement material is knitted, braided, spiraled, woven, maypole, rotary, wrapped, or longitudinally overlapped textile on said inner tubular structure.

37. Th method of claim 28 wh rein said second thermoplastic vulcanizat is foamed.

38. The method of claim 37 further comprising a third thermoplastic vulcanizate disposed betw en said inner tubular structure and said reinforcement m mber wherein said third thermoplastic vulcanizate is foamed.

39. The method of claim 38 wherein said second foamed thermoplastic vulcanizate and said third foamed thermoplastic vulcanizate material exhibit a closed cell structure comprising a thermoplastic polypropylene matrix having dispersed therein a plurality of elastomeric ethylene-propylene-diene rubber globules and a foaming agent, said foamed thermoplastic vulcanizate material exhibiting a specific gravity of about 0.55 to 0.90.

40. The method of claim 28 further comprising applying an adhesive layer between at least one of said thermoplastic vulcanizate inner tubular structure and said reinforcement member, and between said reinforcement member and said thermoplastic vulcanizate protective cover.

41. The hose of claim 40 wherein said adhesive layer is ethylene-propylene-diene rubber.

42. A method of manufacturing a flexible hose for conveying a liquid, said method comprising:
extruding an inner tubular structure comprising a thermoplastic vulcanizate having a thermoplastic polypropylene matrix containing a plurality of crosslinked elastomeric ethylene-propylene-diene rubber globules dispersed therein, said globules having a particle size of about 5 to 50 microns, said inner tubular structure having an inner circumferential surface, and an outer circumferential surface wherein said solid, non-foamed thermoplastic vulcanizate contains about 75 to 25% thermoplastic polypropylene matrix by weight of said thermoplastic vulcanizate and about 25 to 75% elastomeric globules by weight of said thermoplastic vulcanizate;
applying a reinforcement member comprising natural or synthetic fibers selected from the group consisting of nylon fibers, rayon fibers, aramid fibers, cotton fibers, carbon fibers, glass fibers and polyester fibers, or metal wire around the outer circumferential surface of said inner circumferential tubular structure; and
extruding a protective cover around said reinforcement member, said protective cover comprising a thermoplastic vulcanizate comprising a thermoplastic polypropylene matrix containing a plurality of crosslinked elastomeric ethylene-propylene-diene rubber globules having a particl size of about 5 to 50 microns dispersed therein wherein said thermoplastic vulcanizate material contains about 75 to 25% thermoplastic polypropylene matrix by weight of said thermoplastic vulcanizat and about 25 to 75% elastomeric globules by weight of said th rmoplastic vulcanizat.

43. The method of claim 42 wherein said reinforcement material is knitted, braided, spiraled, woven, maypole, rotary, wrapped, or longitudinally overlapped textile on said inner tubular structure.

44. The method of claim 42 further comprising applying an adhesive layer between at least one of said thermoplastic vulcanizate inner tubular structure and said foamed intermediate tubular structure, between said intermediate tubular structure and said reinforcement member, and between said reinforcement member and said foamed protective cover.

45. The method of claim 44 wherein said adhesive layer is ethylene-propylene-diene rubber.

46. A method of manufacturing a flexible hose for conveying a liquid, said method comprising:
extruding a solid, non-foamed inner tubular structure comprising a thermoplastic vulcanizate having a thermoplastic polypropylene matrix containing a plurality of crosslinked elastomeric ethylene-propylene-diene rubber globules dispersed therein, said globules having a particle size of about 5 to 50 microns, said inner tubular structure having an inner circumferential surface, and an outer circumferential surface wherein said solid, non-foamed thermoplastic vulcanizate contains about 75 to 25% thermoplastic polypropylene matrix by weight of said thermoplastic vulcanizate and about 25 to 75% elastomeric globules by weight of said thermoplastic vulcanizate;
extruding an intermediate tubular structure comprising a foamed thermoplastic vulcanizate having a thermoplastic polypropylene matrix containing a foaming agent and a plurality of crosslinked elastomeric ethylene-propylene-diene rubber globules dispersed therein, said globules having a particle size of about 5 to 50 microns wherein said intermediate tubular structure is foamed during extrusion, said foamed intermediate tubular structure having an inner circumferential surface, and an outer circumferential surface wherein said foamed thermoplastic vulcanizat contains about 75 to 25% thermoplastic polypropyl ne matrix by weight of said th rmoplastic vulcanizate and about 25 to 75% elastomeric globules by weight of said thermoplastic vulcanizate;
applying a reinforcement member comprising natural or synthetic fibers selected from the group consisting of nylon fibers, rayon fibers, aramid fib rs, cotton fibers, carbon fibers, glass fibers and polyester fibers, or m tal wire around the outer circumferential surface of said foamed intermediate tubular structure; and
extruding a protective cover around said reinforcement member, said protective cover comprising a thermoplastic vulcanizate having a thermoplastic polypropylene matrix containing a foaming agent and a plurality of crosslinked elastomeric ethylene-propylene-diene rubber globules having a particle size of about 5 to 50 microns dispersed therein wherein said foamed thermoplastic vulcanizate material contains about 75 to 25% thermoplastic polypropylene matrix by weight of said thermoplastic vulcanizate and about 25 to 75% elastomeric globules by weight of said thermoplastic vulcanizate.

47. The method of claim 46 wherein said reinforcement material is knitted, braided, spiraled, woven, maypole, rotary, wrapped, or longitudinally overlapped textile on said inner tubular structure.

48. The method of claim 46 further comprising applying an adhesive layer between at least one of said thermoplastic vulcanizate inner tubular structure and said intermediate tubular structure, between said intermediate tubular structure and said reinforcement member, and between said reinforcement member and said protective cover.

49. The method of claim 46 wherein said foaming agent is a chemical foaming agent selected from the group consisting of blends of citric acid and sodium bicarbonate, azodicarbamide, modified azodicarbamide, hydrazide, 5-phenyltetrazol, p-toluene sulfonyl semicarbazide, N,N′-dinitrosopentamethylenetetraamine, benzenesulfonyl hydrazide, p-toluene sulfonyl hydrazide, and p,p′-oxybis(benzenesulfonyl hydrazide).

50. The method of claim 49 wherein said chemical foaming agent is a blend of citric acid and sodium bicarbonate.

51. The method of claim 46 wherein each of said foamed thermoplastic vulcanizates are foamed during extrusion of said hose.

52. The method of claim 51 wherein said foamed intermediate thermoplastic vulcanizate layer and said foamed th rmoplastic vulcanizate protective cover layer exhibits a closed cell structure having a specific gravity of about 0.55 to 0.90.

53. The method of claim 48 wherein said adhesive layer is ethylene-propylene-diene rubber.
